(19) United States
(12) Patent Application Publication
(10) Pub. No.: US 2008/0172629 A1
(43) Pub. Date: Jul. 17, 2008

(54) Geometric Performance Metric Data Rendering

(75) Inventors: Ian Tien, Seattle, WA (US); Corey J. Hulen, Sammamish, WA (US); Chen-I Lim, Bellevue, WA (US); Ramesh Arimilli, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/624,171

(22) Filed: Jan. 17, 2007

(51) Int. Cl. G06F 17/30; G06F 3/048

(52) U.S. Cl. 715/771; 707/103 R; 707/E17.009

(57) ABSTRACT

Users are enabled to utilize data from performance metrics to drive the behavior of geometric shapes to visualize business performance and create new composite objects that show magnitude, patterns of structured and unstructured data, interrelationships, causalities, and dependencies. Presentations are then rendered in a performance metric application or in another application through an embeddable user interface using the geometric shapes and composite objects. Automatic update of presented information in response to changes in the underlying data is enabled through the use of composite objects.

### BACKGROUND

Key performance indicators (KPIs)—data driven metrics that have the potential to affect the strategic performance of a business—have the potential to grow exponentially with a size of an organization. For example, a manager may have 5-7 KPIs, each of his five subordinates may have 5-7 KPIs as well, and their five subordinates may have 5-7 KPIs too, and soon there are too many metrics for the top level manager to understand. If one of the metrics is server down time at 0.5% above its target and another metric is customer satisfaction at 0.25 points below its target, which is a higher priority?

Without the ability to assess the severity of underperforming metrics, only unstructured and informal avenues of assessment, made largely on opinion, can be used on prioritization. This may introduce inconsistency, compliance risks, and liability, particularly as top level managers are increasingly being held accountable for the actions of staff across the breadth of their organizations.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to enabling users to utilize data from performance metrics to set a behavior and attributes of geometric units to visualize performance metric analysis and create new composites that display magnitude, patterns of structured and unstructured data, interrelationships, causalities, or dependencies.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an example scorecard architecture;

FIG. 2 illustrates a screenshot of an example scorecard;

FIG. 3 is a flow diagram of performance metric data operations in an example scorecard application.

FIG. 4 illustrates a screenshot of an example performance metric definition user interface;

FIG. 5 illustrates a screenshot of an example strategy map in a native application user interface;

FIG. 6 is a screenshot illustrating the pan and zoom features on the example strategy map of FIG. 5;

FIG. 7 is a screenshot illustrating the search features on the example strategy map of FIG. 5;

FIG. 8 illustrates an example process diagram as an alternative presentation of the native application of FIG. 5;

FIG. 9 illustrates updating of performance metric based charts using composite objects;

FIG. 10 illustrates an example strategy map detail with composite objects;

FIG. 11 illustrates details of the composite objects used in the strategy map of FIG. 10;

FIG. 12 illustrates a screenshot of an example embeddable authoring user interface for generating performance metric based visualizations;

FIG. 13 is a diagram of a networked environment where embodiments may be implemented;

FIG. 14 is a block diagram of an example computing operating environment, where embodiments may be implemented; and

FIG. 15 illustrates a logic flow diagram for a process of rendering geometric performance metric data.

### DETAILED DESCRIPTION

As briefly described above, users are enabled to utilize data from key performance indicators to drive the behavior of geometric units to visualize organizational performance. In the following detailed description, references are made to the accompanying drawings that form a part hereof, and in which are shown by way of illustrations specific embodiments of examples. These aspects may be combined, other aspects may be utilized, and structural changes may be made without departing from the spirit and scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instruction for executing a computer process.

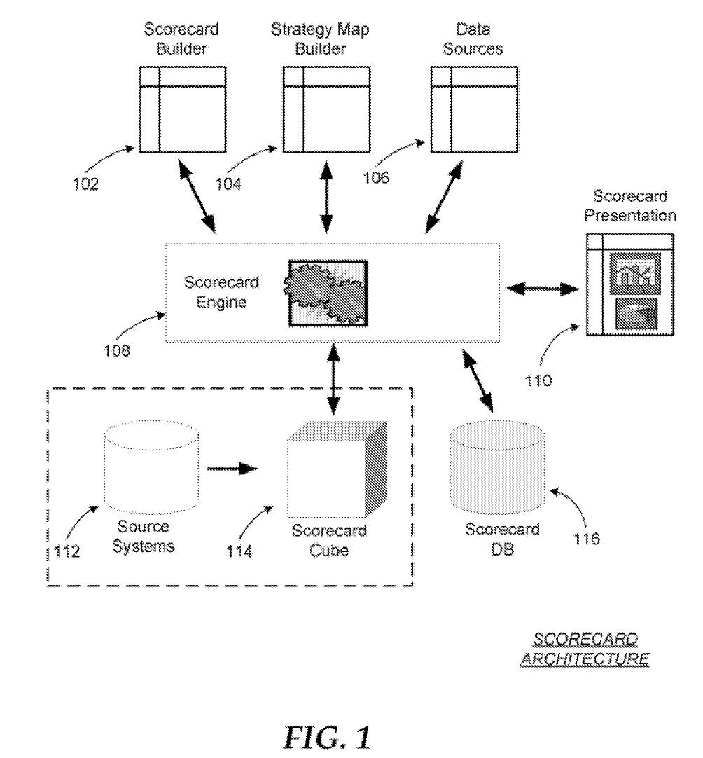

Referring to FIG. 1, an example scorecard architecture is illustrated. The scorecard architecture may comprise any topology of processing systems, storage systems, source systems, and configuration systems. The scorecard architecture may also have a static or dynamic topology.

Scorecards are an easy method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture, a core of the system is scorecard engine 108. Scorecard engine 108 may be an application software that is arranged to evaluate performance metrics. Scorecard engine 108 may be loaded into a server, executed over a distributed network, executed in a client device, and the like.

Data for evaluating various measures may be provided by a data source. The data source may include source systems 112, which provide data to a scorecard cube 114. Source systems 112 may include multi-dimensional databases such OLAP, other databases, individual files, and the like, that provide raw data for generation of scorecards. Scorecard cube 114 is a multi-dimensional database for storing data to be used in determining Key Performance Indicators (KIPs) as well as generated scorecards themselves. As discussed above, the multi-dimensional nature of scorecard cube 114 enables storage, use, and presentation of data over multiple dimensions such as compound performance indicators for different geographic areas, organizational groups, or even for different time intervals. Scorecard cube 114 has a bi-directional interaction with scorecard engine 108 providing and receiving raw data as well as generated scorecards.

Scorecard database 116 is arranged to operate in a similar manner to scorecard cube 114. In one embodiment, scorecard database 116 may be an external database providing redundant back-up database service.

Scorecard builder 102 may be a separate application or a part of a business logic application such as the performance evaluation application, and the like. Scorecard builder 102 is employed to configure various parameters of scorecard engine 108 such as scorecard elements, default values for actuals, targets, and the like. Scorecard builder 102 may include a user interface such as a web service, a GUI, and the like.

Strategy map builder 104 is employed for a later stage in scorecard generation process. As explained below, scores for KPIs and other metrics may be presented to a user in form of a strategy map. Strategy map builder 104 may include a user interface for selecting graphical formats, indicator elements, and other graphical parameters of the presentation.

Data Sources 106 may be another source for providing raw data to scorecard engine 108. Data sources 106 may also define KPI mappings and other associated data.

Additionally, the scorecard architecture may include scorecard presentation 110. This may be an application to deploy scorecards, customize views, coordinate distribution of scorecard data, and process web-specific applications associated with the performance evaluation process. For example, scorecard presentation 110 may include a web-based printing system, an email distribution system, and the like. In some embodiments, scorecard presentation 110 may be an interface that is used as part of the scorecard engine to export data for generating presentations or other forms of scorecard-related documents in an external application. For example, metrics, reports, and other elements (e.g. commentary) may be provided with metadata to a presentation application (e.g. PowerPoint® of MICROSOFT CORPORATION of Redmond, Wash.), a word processing application, or a graphics application to generate slides, documents, images, and the like, based on the selected scorecard data. In other embodiments, scorecard presentation 110 may enable visualizations of performance metric based data using composite objects.

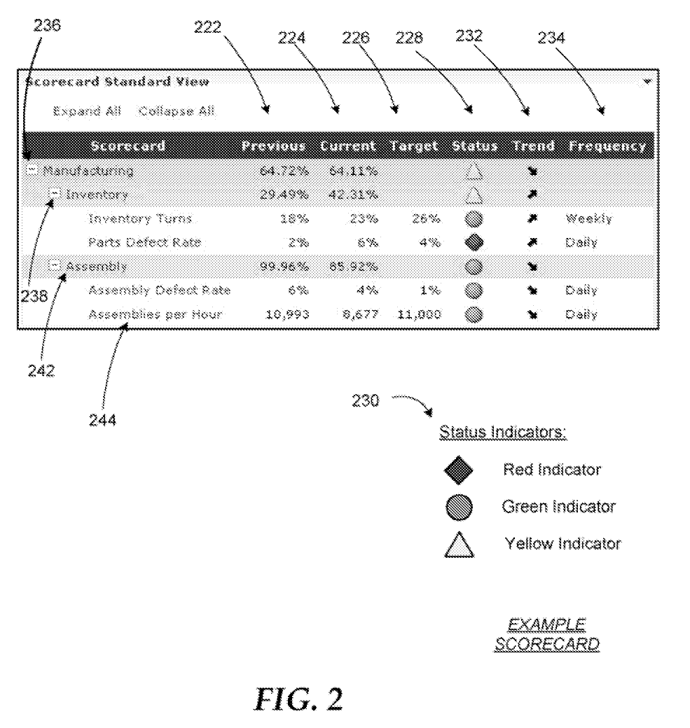

FIG. 2 illustrates a screenshot of an example scorecard with status indicators 230. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different score card managers might have a shared KPI in common. This may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The arrows displayed in the scorecard of FIG. 2 indicate how the numbers are moving this period compared to last. If in this period the number is greater than last period, the trend is up regardless of the trend type. Possible trend types may include: Increasing Is Better, Decreasing is Better, and On-Target is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent metric.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, data, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of the scorecard shows example top level metric 236 “Manufacturing” with its reporting KPIs 238 and 242 “Inventory” and “Assembly”. Second column 222 in the scorecard shows results for each measure from a previous measurement period. Third column 224 shows results for the same measures for the current measurement period. In one embodiment, the measurement period may include a month, a quarter, a tax year, a calendar year, and the like.

fourth column 226 includes target values for specified KPIs on the scorecard. Target values may be retrieved from a database, entered by a user, and the like. Column 228 of the scorecard shows status indicators 230.

Status indicators 230 convey the state of the KPI. An indicator may have a predetermined number of levels. A traffic light is one of the most commonly used indicators. It represents a KPI with three-levels of results—Good, Neural, and Bad. Traffic light indicators may be colored red, yellow, or green. In addition, each colored indicator may have its own unique shape. A KPI may have one stoplight indicator visible at any given time. Other types of indicators may also be employed to provide status feedback. For example, indicators with more than three levels may appear as a bar divided into sections, or bands. Column 232 includes trend type arrows as explained above under KPI attributes. Column 234 shows another KPI attribute, frequency.

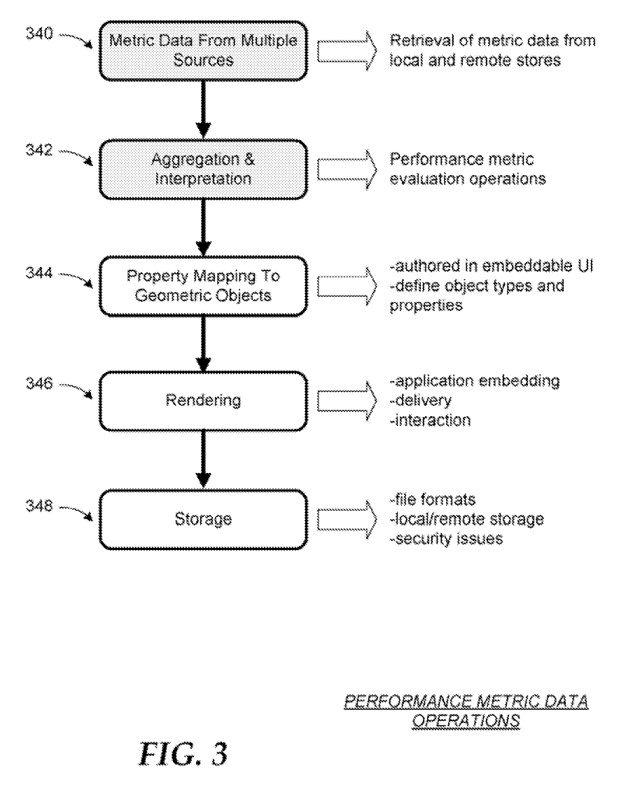

FIG. 3 is a flow diagram of performance metric data operations in an example scorecard application. The operations may be performed by a business logic service that collects, processes, and analyzes performance data from various aspects of an organization and presents the data as well as analysis results based on the data to subscribers. Embodiments according to this disclosure are focused on operations 344 through 348.

Performance metric operations begin with collection of metric data from multiple sources (340), which may include retrieval of data from local and remote data stores. Collected data is then aggregated and interpreted (342) according to default and subscriber defined configuration parameters of the business service. For example, various metric hierarchies, attributes, aggregation methods, and interpretation rules may be selected by a subscriber from available sets.

Once the aggregation and interpretation is accomplished, the service can provide a variety of presentations based on the results. In some cases, the raw data itself may also be presented along with the analysis results. Property mapping to geometric objects operation (344) may be configured employing a native application user interface or an embeddable user interface that can be launched from any presentation application such as a graphics application, a word processing application, a spreadsheet application, and the like. Using this interface objects, object types, and their properties may be defined.

Upon defining the objects to be used in the presentation, the presentation may be rendered (346) with several configurable aspects. The rendering may include application embedding, caching of data for offline operation or versioning purposes, different delivery options (e.g. by email, web publishing, file sharing, etc.). Rendering may also involve subscriber interaction such as zoom, pan, click, search, and the like. An optional operation in performance metric data processing is storage (348), where rendered presentations (e.g. reports) may be stored using various file formats in local or remote data stores. Security issues may also be addressed at this operation or at the delivery phase of rendering (346).

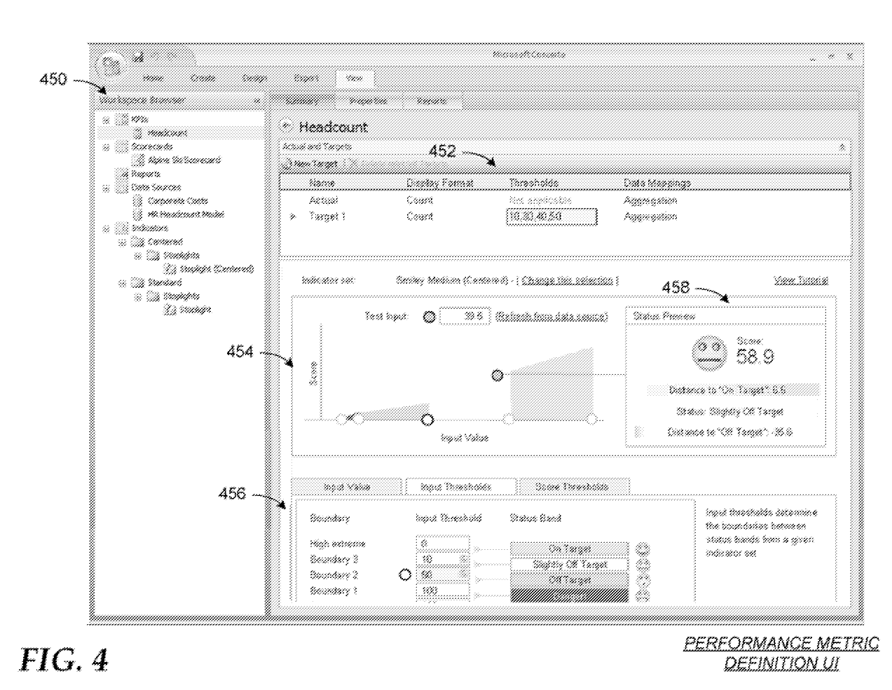

FIG. 4 illustrates a screenshot of an example performance metric definition user interface. Side panel 450 titled “Workspace Browser” provides a selection of available scorecards and KPIs for authoring, as well as other elements of the scorecards such as indicators and reports. A selected element, “headcount”, from the workspace browser is shown on the main panel 452.

The main panel 452 includes a number of detailed aspects of performance metric computation associated with “headcount”. For example formats, associated thresholds, and data mapping types for actuals and targets of “headcount” are displayed at the top. The indicator set is described and a link provided for changing to another indicator set (in the example Smiley style indicators are used). A preview of scores vs. inputs (454) and status (458) for a test input are also provided. The input thresholds and the status bands, which determine how inputs are distributed along the input value axis are shown for each boundary value in a definition section (456) at the bottom of the user interface. The definition section may be a tabbed portion of the user interface for defining input and score thresholds such that scores may be computed for each input based on the defined relationship. The previews (454 and 458) may be updated automatically in response to subscriber changes in the definition section 456 for any boundary or threshold values. Furthermore, the boundary values and associated thresholds may be set or modified by the subscriber graphically on the preview chart by moving around the boundary indicators.

As shown at the top of the example screenshot, the definition user interface may be provided in a tabbed format, where different aspects of the user interface may be displayed for different tasks associated with performance metric processing, such as design, create, export, or view. Once the elements and relationships are defined, the performance metric application may retrieve data from the selected sources and perform computations to determine scores, statuses, and the like. A statistical analysis for past performance and/or future forecast may also be carried out. A next step in the scorecard process is generation of presentations based on the performance metric data and the analysis results. Reports comprising charts, grip presentations, graphs, three dimensional visualizations, and the like may be generated based on selected portions of available data. According to embodiments, geometric objects may be employed to create such presentations by mapping object properties.

Standard geometric visualizations, such as charts and graphs, can be modeled as the composite of smaller geometric units. For example, a bar graph is a series of height varying quadrilaterals, a trend chart is a series of small circles in specific positions. As mentioned previously, embodiments are directed to enabling users to utilize data from key performance indicators to drive the behavior of geometric units to visualize business performance and create new composites that show magnitude, patterns of structured and unstructured data, interrelationships, causalities, and dependencies. Methods for visualizing an output of quantitative models built to assess and compare the severity of KPIs and their impact on other metrics are also provided. Through visualizing outputs of quantitative models business users may be enabled to make faster, more relevant decisions based on data that is readily interpreted.

Rendering of presentations from scorecard data may be a one time event and the presentations may be stationary, meaning the data in the presentation is not dynamic as presented by the scorecard application. On the other hand, scorecard views (as well as report views) may be repeated for data associated with a particular time period without substantially changing format. For example, a user may want to view the scorecard (select metrics) and associated reports for fiscal year 2006. Then, the user may desire to check the views for fiscal year 2005 or any other year. To accommodate an efficient and seamless updating of the presentation for different versions of the same dimension, scorecard data may be cached. This way, multiple versions of the presentation can be generated for cached versions of data such as by time period. A similar caching and presentation method may be employed for other dimensions such as region, organizational unit, etc.

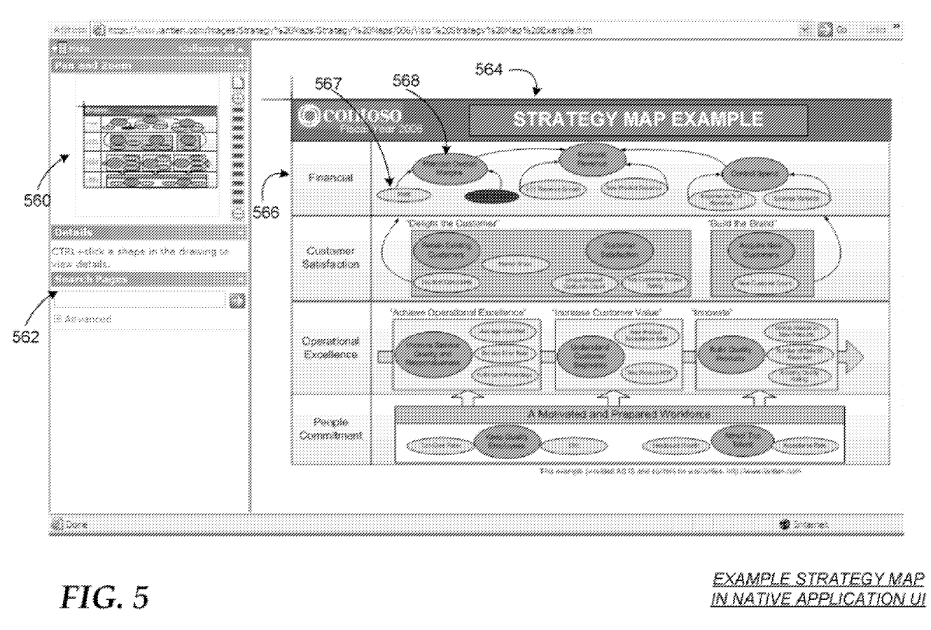

FIG. 5 illustrates a screenshot of an example strategy map in a native application user interface. Strategy maps are a way of providing a macro view of an organization's strategy, and provide it with a language in which they can describe their strategy, prior to constructing metrics to evaluate performance against their strategies.

As the name suggests, objectives and goals of an organization may be organized in a strategy map categorized by type, organizational structure, and the like, to reflect an overall strategy. For each top level objective, reporting lower level objectives or metrics may be included and the relationships between those displayed. Hence, the strategy map provides a visualization of metrics that drive objectives and their interrelationships within an organization. In addition, a current status of each displayed metric or objective may also be displayed by color coding (e.g. background color of the objects representing objectives and metrics), annotations, or composite objects associated with each metric or objective. For example, metrics that are on target may be assigned a green background color, while those slightly below may be assigned a yellow background color (indicating a warning), and those significantly below target may be assigned red background color. A color of an objective with multiple reporting metrics may be determined by aggregation of the colors of reporting metrics. Furthermore, background colors indicating status may be assigned to groups of objectives. Another implementation may include composite objects such as gauges inserted into each geometric object representing a metric or objective on the strategy map.

A user interface for generating and/or presenting performance metric based data such as strategy maps may be part of a native application (e.g. a scorecard application), or it may be an embeddable user interface that can be launched from any other application. The example screenshot of FIG. 5 is part of a native application. Strategy map 564 is illustrated on a main panel of the user interface. The strategy map includes several top level objectives such as financial objective 566. Other categories include customer satisfaction, operational excellence, and people commitment.

Each top level objective may include a number of metrics, which themselves may be grouped under sub-objectives or have a multi-layered reporting structure. For example, under the financial objective 566, KPIs “Expense as % of Revenue” and Expense Variance” report to KPI “Control Spending”, which along with “Maintain Overall Margins” reports to sub-objective “Increase Revenue”.

As mentioned above, background color coding may be employed to reflect a current status of each metric or objective. Lighter colored KPI “Profit” 567 indicates on on-target status, while the darker colored KPI “Maintain Overall Margins” 568 indicates a below target status due to significantly off target status of another reporting KPI.

The authoring and presentation user interface may include side panels for different functionalities. For example, side panel 560 provides pan and zoom functionality on the displayed strategy map, while side panel 562 provides search features.

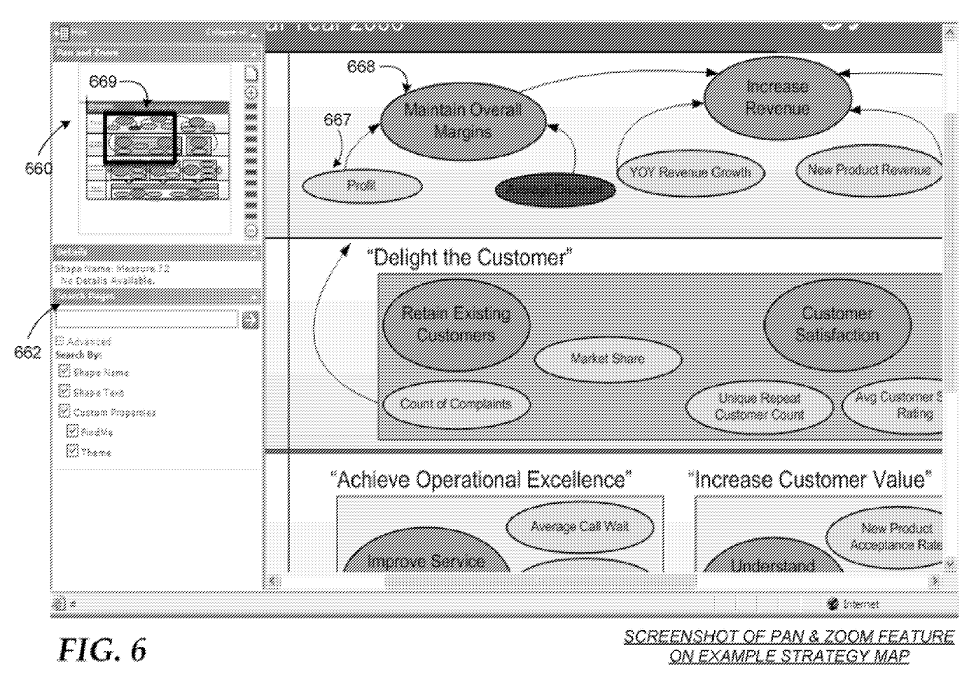

FIG. 6 is a screenshot illustrating the pan and zoom features on the example strategy map of FIG. 5. In response to selection of a focus area 669 on side panel 660, the view on the main panel zooms in and pans the focus area indicated on the side panel. Objective 668 and its reporting KPI 667 can now be seen in more detail. By moving the focus area 669 around on side panel 660, a subscriber can pan to different sections of the strategy map. Search functionality is till provided on side panel 662.

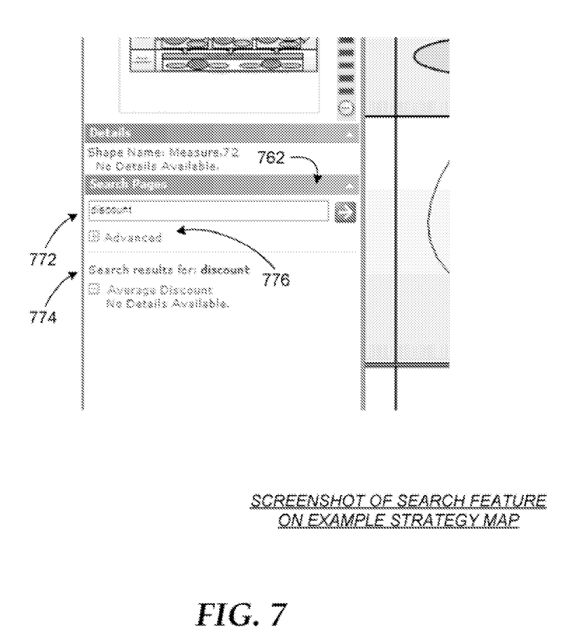

FIG. 7 is a screenshot illustrating the search features on the example strategy map of FIG. 5. The detailed view of search functionality on side panel 774 that lists elements found associated with the search term, and an advanced search configuration portion 776. The advanced search configuration portion and the search results may be provided in collapsible form or in pop-up window form depending on a layout configuration.

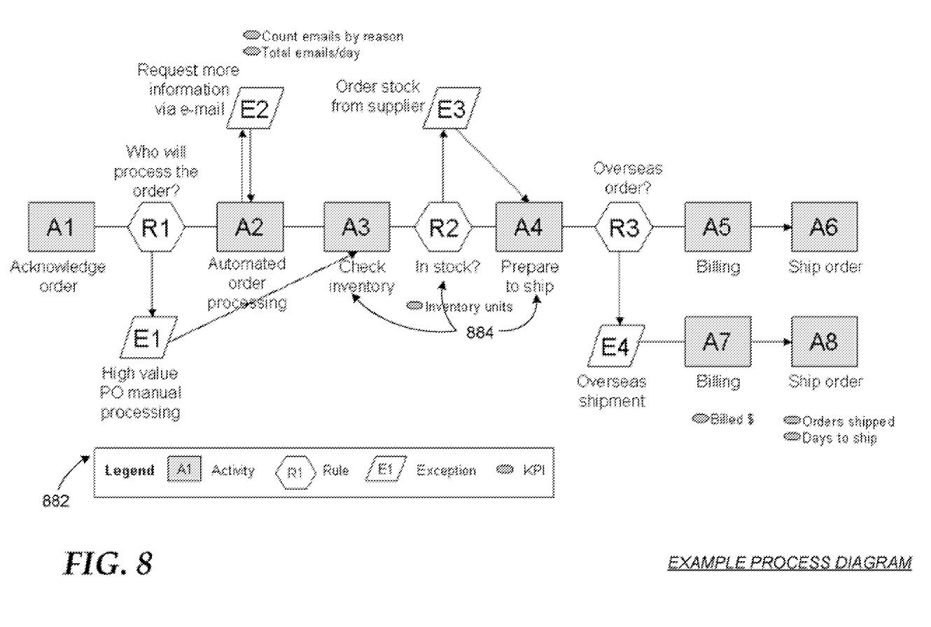

FIG. 8 illustrates an example process diagram as an alternative presentation of the native application of FIG. 5. Performance metric data and analysis results may be presented in many forms. Strategy map described above is one example. Another example is a process diagram that displays various steps in an organizational process such as life cycle of a product from order receipt to shipment. The example process diagram in FIG. 8 shows such a process and how geometric objects may be used in creating the process diagram based on performance metrics providing subscribers insightful and up-to-date information about the process.

Different nodes of the process diagram such as nodes 884 are represented by geometric objects depending on a type of the node. For example, activities are represented by rectangles, rule by hexagons, and so on. Each node may be annotated with a brief description of the step it represents. Arrows indicate interrelationships between different nodes and a direction of process flow. For may steps along the process, performance metric data may be collected and status determined based on a comparison of actual versus target values. The status foe each node may be presented as a background color according to a status-coloring scheme, a metric icon adjacent to the node, and the like. The metric icons may include geometric objects colored and/or shaped according to the current status or composite objects such as gauges that reflect the status. Legend 882 provides a definition of the objects in the diagram for representing nodes and metric icons.

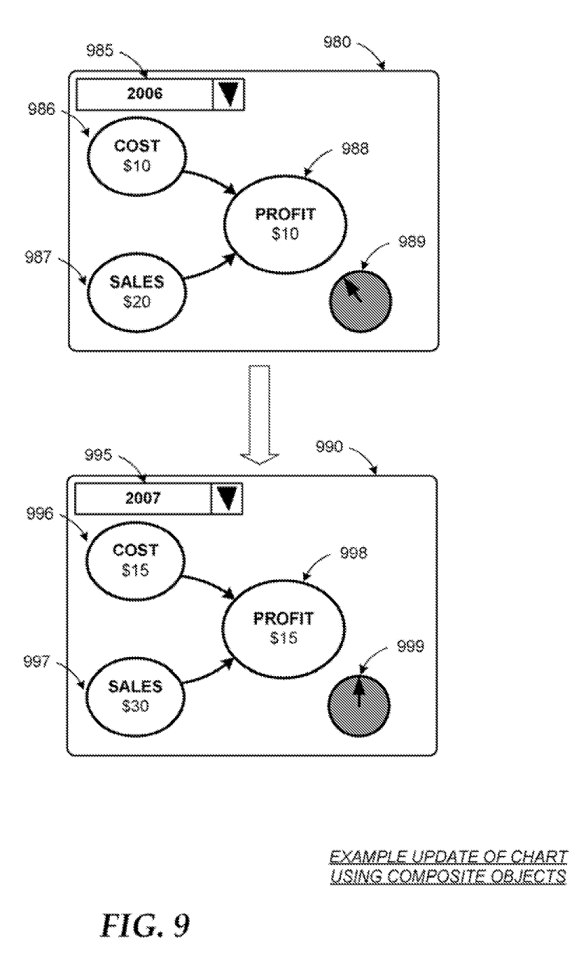

FIG. 9 illustrates updating of performance metric based charts using composite objects. Charts 980 and 990 show a simple metric presentation based on data for two different periods. Chart 980 includes objects 986 representing “Cost” and 987 representing “Sales” reporting to the object 988 representing “Sales”. Each object has an actual value embedded inside. A gauge object 989 displays the status of the top level metric “Profit” for fiscal year 2006 based on a comparison of target value and the actual value. The selected fiscal year (2006) is reflected on the drop-down menu 985.

In the second chart 990, the drop-down menu 995 reflects a new selected fiscal year (2007). The actuals for “Cost” (996) and “Sales” 997″ are different and the embedded actuals in the objects have been updated in response to the selection of the new fiscal period. The actual for “Profit” 998 has also changed as reflected by the embedded number. Finally, the composite object, gauge, 999 showing the status is also updated based on the new data. The use of composite objects enables the presentation application to provide automatic updates on performance metric data based presentations as the underlying data changes.

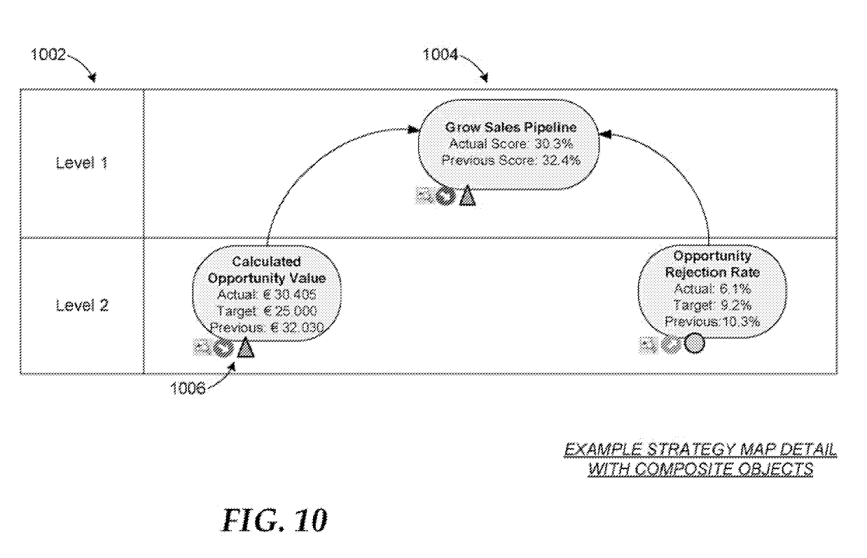

FIG. 10 illustrates an example strategy map detail with composite objects. Composite objects may be employed in performance metric data based presentations in various ways. The example strategy map of FIG. 10 shows a few of such ways.

The strategy map includes two levels (1002) of objectives with two objectives on level 2 reporting to objective 1004 on level 1. Elliptic geometric shapes are used to represent the objectives with textual information provided within the objects. The textual information includes a description of each objective, actual and target values for each objective and previous actuals for each objective. The metric data in the presentation is connected to the computation engine such that any changes in the underlying data can be reflected by updating the objects. Moreover, a capability of the computation engine to work with a diversity of data (currency, percentage, etc.) and still compute statuses is also reflected in the presentation by showing the metric data in their original format (e.g. euro, percentage).

Also included in the presentation are smaller composite objects or icons (1006) for further status indication. These include trend icons, status indicators according to a selected scheme, and so on. By using composite objects as opposed to bitmap images or other types of data inherent limitations of these types of objects are overcome providing a dynamic link between the presentation and the performance metric computation.

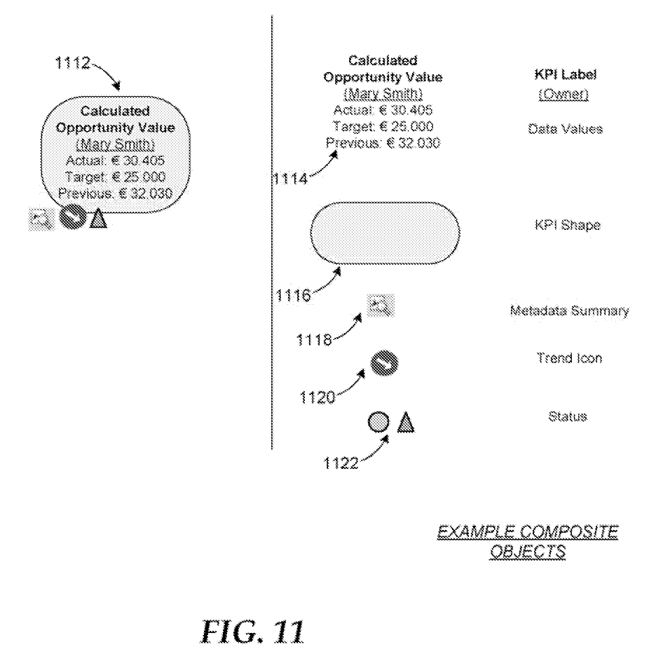

FIG. 11 illustrates details of the composite objects used in the strategy map of FIG. 10. The group of composite objects 1112 represents one of the objectives in the previous strategy map along with the status indication. As mentioned above, geometric shape 1116 is the KPI shape used in the diagram. Text 1114 includes KPI label (also optionally the owner) and data values such as actuals, targets, etc. The icons may include a metadata summary icon 118, a trend icon 1120, and status indicators 1122. It should be noted, that other types of icons for providing additional information may also be used as well as additional textual data.

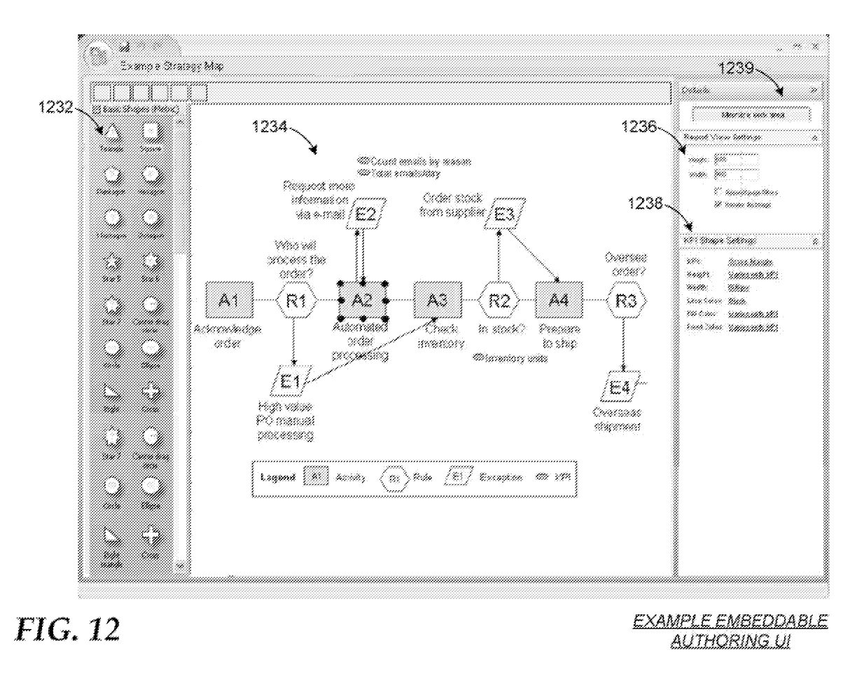

FIG. 12 illustrates a screenshot of an example embeddable authoring user interface for generating performance metric based visualizations. In addition to providing presentations using geometric objects based on the performance metric data, presentations may also be created, authored, and rendered in other applications by embedding an authoring user interface into any application. If the embedded application is a graphics application that provides a selection of objects such as VISIO® by MICROSOFT CORP. of Redmond, Wash., the embeddable authoring user interface may utilize those objects to create the presentation

In the example screenshot, objects 1232 are drag-on style shapes provided by the embedded application. The embeddable user interface provides the main panel displaying process diagram 1234 and side panel 1239 displaying report view settings 1236 and shape settings 1238 enabling the subscriber to define layout parameters of the presentation from within the embedded application.

During an operation, a new map may be automatically opened in the embedded application and show KPI Groups and KPIs in a level-based hierarchy as in the original map of the native application, in response to a request form a subscriber to launch the embeddable authoring user interface. The KPI and KPI Group stencils may be rearranged and new arrows and labels added to illustrate the cause and effect relationships among the elements.

Additional details may also be added to the diagram by hiding and unhiding layer stencils such that elements show actual, target, or previous values, and icons for status, trend, and annotations. Status indicators may be grouped by default with their associated scorecard elements. Moreover, using the embeddable authoring editor additional KPIs and KPI Groups may be added. The presentation (strategy map) may be previewed in a preview user interface of the embedded application. Other functions such as printing may also be performed through the embedded application.

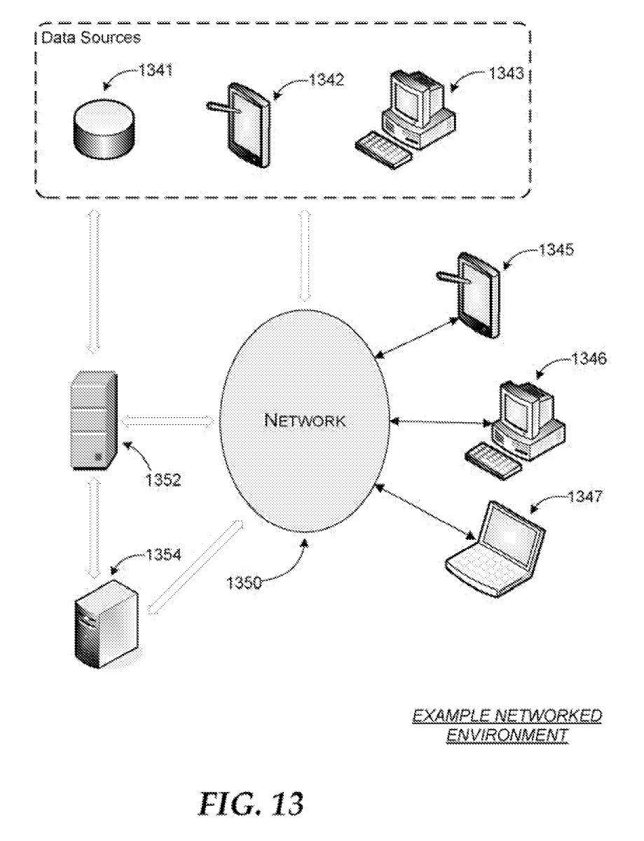

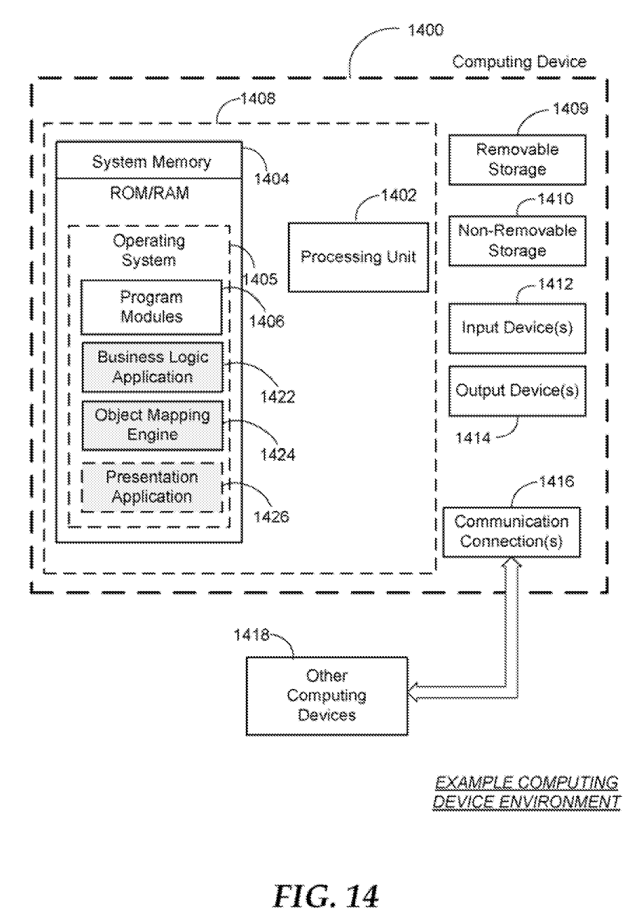

Referring now to the following figures, aspects and exemplary operating environments will be described. FIG. 13, FIG. 14, and the associated discussion are intended to provide a brief, general description of a suitable computing environment in which embodiments may be implemented.

FIG. 13 is a diagram of a networked environment where embodiments may be implemented. The system may comprise any topology of servers, clients, Internet service providers, and communication media. Also, the system may have a static or dynamic topology. The term “client” may refer to a client application or a client device employed by a user to perform operations associated with rendering performance metric data using geometric objects. While a networked business logic system may involve many more components, relevant ones are discussed in conjunction with this figure.

In a typical operation according to embodiments, business logic service may be provided centrally from server 1352 or in a distributed manner over several servers (e.g. servers 1352 and 1354) and/or client devices. Server 1352 may include implementation of a number of information systems such as performance measures, business scorecards, and exception reporting. A number of organization-specific applications including, but not limited to, financial reporting/analysis, booking, marketing analysis, customer service, and manufacturing planning applications may also be configured, deployed, and shared in the networked system.

Data sources 1341-1343 are examples of a number of data sources that may provide input to server 1352. Additional data sources may include SQL servers, databases, non multi-dimensional data sources such as text files or EXCEL® sheets, multi-dimensional data source such as data cubes, and the like.

Users may interact with server running the business logic service from client devices 1345-1347 over network 1350. In another embodiment, users may directly access the data from server 1352 and perform analysis on their own machines.

Client devices 1345-1347 or servers 1352 and 1354 may be in communications with additional client devices or additional servers over network 1350. Network 1350 may include a secure network such as an enterprise network, an unsecure network, such as a wireless open network, or the Internet. Network 1350 provides communication between the nodes described herein. By way of example, and not limitation, network 1350 may include wired media such as a wired network or direct-wired connection, and wireless media such as acoustic, RF, infrared and other wireless media.

Many other configurations of computing devices, applications, data sources, data distribution and analysis systems may be employed to implement rendering of performance metric based presentations using geometric objects. Furthermore, the networked environments discussed in FIG. 13 are for illustration purposes only. Embodiments are not limited to the example applications, modules, or processes. A networked environment for may be provided in many other ways using the principles described herein.

With reference to FIG. 14, a block diagram of an example computing operating environment is illustrated, such as computing device 1400. In a basic configuration, the computing device 1400 typically includes at least one processing unit 1402 and system memory 1404. Computing device 1400 may include a plurality of processing units that cooperate in executing programs. Depending on the exact configuration and type of computing device, the system memory 1404 may be volatile (such as RAM), non-volatile (such as ROM, flash memory, etc.) or some combination of the two. System memory 1404 typically includes an operating system 1405 suitable for controlling the operation of a networked personal computer, such as the WINDOWS® operating systems from MICROSOFT CORPORATION of Redmond, Wash. The system memory 1404 may also include one or more software applications such as program modules 1406, business logic application 1422, object mapping engine 1424, and optional presentation application 1426.

Business logic application 1422 may be any application that processes and generates scorecards and associated data. Object mapping engine 1424 may be a module within business logic application 1422 that manages definition of object types and properties for rendering of presentations based on performance metric data and analysis results. Presentation application 1426 or business logic application 1422 itself may render the presentation(s) using the objects defined by the object mapping engine 1424. Presentation application 1426 or business logic application 1422 may be executed in an operating system other than operating system 1405. This basic configuration is illustrated in FIG. 14 by those components within dashed line 1408.

The computing device 1400 may have additional features or functionality. For example, the computing device 1400 may also include additional data storage devices (removable and/or non-removable) such as, for example, magnetic disks, optical disks, or tape. Such additional storage is illustrated in FIG. 14 by removable storage 1409 and non-removable storage 1410. Computer storage media may include volatile and non-volatile, removable and non-removable media implemented in any method or technology for storage of information, such as computer readable instructions, data structures, program modules, or other data. System memory 1404, removable storage 1409 and non-removable storage 1410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1400. Any such computer storage media may be part of device 1400. Computing device 1400 may also have input device(s) 1412 such as keyboard, mouse, pen, voice input device, touch input device, etc. Output device(s) 1414 such as a display, speakers, printer, etc. may also be included. These devices are well known in the art and need not be discussed at length here.

The computing device 1400 may also contain communication connections 1416 that allow the device to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

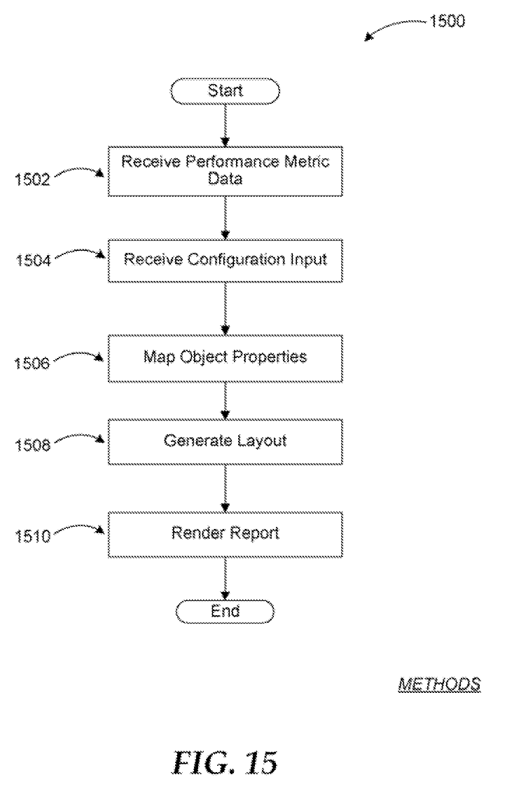

FIG. 15 illustrates a logic flow diagram for a process of rendering geometric performance metric data. Process 1500 may be implemented in a business logic service that processes and/or generates scorecards and scorecard-related reports.

Process 1500 begins with operation 1502, where performance metric data (and/or analysis results based on the performance metric data) is received. Processing advances from operation 1502 to operation 1504.

At operation 1504, configuration input is received. Configuration input may include any information received from a subscriber or an application associated with the business logic service for defining objects to be used in rendering presentations and their attributes. Additional configuration input may include parameters associated with application embedding (if the authoring user interface is an embedded one), caching and delivery options, storage options, and the like. Processing proceeds from operation 1504 to operation 1506.

At operation 1506, object properties are mapped. Object properties may include geometric object properties such as size, rotation, outline color and width, background color and width (as well as patterns), whether a raster image is to be used, whether the object is a composite object (if so behavior parameters), and so on. In further embodiments, a property of one object may serve as a portion of the performance metric data associated with another object. For example, when suing visual modeling that is driven by input from a sensor, multiple visual representations (e.g. warning symbols) may be daisy-chained to a single input (e.g. a diagram of a water treatment plant). Processing moves from operation 1506 to operation 1508.

At operation 1508, a layout of the presentation may be generated based on the mapped object properties and relations and dependencies defined by the performance metric data. At this point, a preview may be provided to the subscriber for modification of a portion or all of the properties. Processing advances to operation 1510 from operation 1508.

At operation 1510, the presentation is rendered. The presentation may be a report according to some embodiments. The rendered presentation may be delivered according to delivery configuration(s) provided by the subscriber (or default parameters) or stored. After operation 1510, processing moves to a calling process for further actions.

The operations included in process 1500 are for illustration purposes. Rendering presentations based on performance metric data using geometric objects may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for rendering a performance metric based presentation using geometric objects, the method comprising:
receiving performance metric data;
mapping a portion of the performance metric data to at least one from a set of: a first geometric object, an attribute of the first geometric object and a relationship between the first geometric object and a second geometric object representing another portion of the performance metric data;
receiving configuration input associated with the presentation;
generating a layout for the presentation based on the mapping and the configuration input; and
rendering the presentation based on the layout.

2. The method of claim 1, wherein the performance metric data includes at least one from a set of: a scorecard element value, an analysis result, a partial scorecard view, a full scorecard view, a report view, and unstructured data.

3. The method of claim 1, wherein receiving the configuration input includes at least one from a set of:
receiving a user selection of the first geometric object and the second geometric object from a group of available objects;
receiving a user selection for at least one attribute of the first geometric object and at least one attribute of the second geometric object; and
receiving a user selection for a lay out attribute.

4. The method of claim 3, further comprising:
receiving a user selection for a delivery of the presentation including at least one from a set of: electronic mail, file share, web publishing, creating a dynamic visual representation, and storage at a designated data store;
receiving a user selection for a frequency of delivery of the presentation; and
delivering the presentation based on the received user selections.

5. The method of claim 1, further comprising:
caching the performance metric data such that a plurality of versions of the presentation can be rendered.

6. The method of claim 1, wherein the first and second geometric objects are composite objects such that elements of the presentation are updated when the performance metric data is modified.

7. The method of claim 1, further comprising at least one of: exporting the presentation to a static image representation, and storing the rendered presentation in one of a local and a remote data store employing one of a default and a user-defined file format.

8. The method of claim 1, further comprising:
storing at least one of the mappings and definitions of the first and second object as an Extensible Markup Language (XML) file.

9. The method of claim 1, wherein rendering the presentation includes providing a user interaction feature comprising at least one from a set of: zoom, pan, and search on the presentation.

10. The method of claim 1, wherein a property of the second geometric object is configured to represent a portion of performance metric data associated with the first geometric object.

11. The method of claim 1, wherein the mapped attribute of the first geometric object includes at least one from a set of: a size, a rotation, a background color, a foreground color, an outline color, an outline thickness, a position of the object.

12. The method of claim 1, wherein mapping the portion of the performance metric data and rendering the presentation are performed employing one of: a user interface in a native performance metric application and an embeddable user interface embedded in another application.

13. A system for rendering a performance metric based presentation using geometric objects, comprising:
a memory;
a processor coupled to the memory, wherein the processor is configured to execute instructions to perform actions including:
receive performance metric data;
determine a selection of objects to be associated with portions of the performance metric data;
map the portions of the performance metric data to the selected objects, properties of selected objects, and visual relationships between the selected objects;
provide a preview of the presentation based on a layout generated employing the mapped objects, properties, and object relationships;
receive configuration input associated with the presentation; and
render the presentation based on the input.

14. The system of claim 13, wherein the processor is further configured to determine the selection of objects by one of: an automatic assignment and a user selection.

15. The system of claim 13, wherein the processor is further configured to:
cache received performance data; and
automatically filter the presentation based on a dimension member selection using the cached data.

16. The system of claim 13, wherein the processor is further configured to accept configuration input from a user and deliver the rendered presentation to the user based on a permission level of the user.

17. A computer-readable storage medium with instructions stored thereon for rendering a performance metric based presentation using geometric objects, the instructions comprising:
receiving performance metric data from at least one data source;
selecting at least one object to be associated with a portion of the performance metric data;
mapping the portion of the performance metric data to one of the selected object, a property of the selected object, and a visual relationship between the selected object and another object;
providing a preview of the presentation based on a layout generated employing the mapped object, property, and object relationship;
receiving a configuration input associated with the presentation;
rendering the presentation based on the input;
delivering the presentation using at least one from a set of: electronic mail, file share, web publishing, storage at a designated data store based on one of a default parameter and a user defined parameter; and
enabling a user to perform operations including at least one of: zoom, pan, and search on the rendered presentation.

18. The computer-readable storage medium of claim 17, wherein the instructions further include providing the preview and the rendered presentation and receiving the user input employing an embeddable user interface.

19. The computer-readable storage medium of claim 18, wherein the embeddable user interface is embedded into a graphics application and the object is one of a group of objects available from the graphics application.

20. The computer-readable storage medium of claim 17, wherein the object is a composite object that is automatically updated based on a change to the performance metric data.
